(19) United States
(12) Patent Application Publication
(10) Pub. No.: US 2011/0282607 A1
(43) Pub. Date: Nov. 17, 2011

(54) ELECTRICAL CONTINUITY ANALYZER

(76) Inventor: Aaron Anderw Tunell, Tucson, AZ (US)

(21) Appl. No.: 13/107,124

(22) Filed: May 13, 2011

Related U.S. Application Data
(60) Provisional application No. 61/334,833, filed on May 14, 2010.

(51) Int. Cl. G06F 19/00

(52) U.S. Cl. 702/65

(57) ABSTRACT

A wireless electrical continuity analyzer of the present invention is used for testing the continuity of an electrical network having a plurality of testing points, each testing point including a plurality of pins. The analyzer includes a plurality of remote testers each having a wireless transceiver, a plurality of pin connectors, and a microcontroller. The pin connectors of each of the plurality of remote testers are configured for connection to pins of respective ones of the plurality of testing points. The continuity analyzer further includes a central computer system wirelessly connected to each of the plurality of remote testers. The central computer system sends a first wireless signal to a first of the remote testers activating at least one pin of the testing point associated with said first remote tester, and sends a second wireless message to all other remote testers to cause the other remote testers to sense voltages received at each pin.

### PRIORITY CLAIM AND CROSS REFERENCE

This application claims the benefit of U.S. Provisional. Application No. 61/334,833, filed May 14, 2010.

### FIELD

A field of the present invention is circuit analyzers. In particular, the invention relates to wireless circuit analyzers for use with wire harnesses.

### BACKGROUND

Wire harnesses are commonly used in vehicles such as aircraft and automobiles, construction machinery, and other apparatus. The harness includes a plurality of wires bound together to provide a more easily installed, more reliable, connection among multiple electrical devices located in various locations within a vehicle. The ends of the wires included in the harness are fitted with any required terminals and/or connector housings for connection to the various electrical elements of the vehicle or other apparatus.

It is also necessary to test assembled wire harness to determine continuity and to verify correct assembly. Large wired testing apparatuses are typically constructed to perform such tests. Constructing, storing and maintaining testing apparatus is costly and inconvenient, particularly for seldom-used wire harness designs.

Further, a manufacturer typically begins construction of the testing apparatus prior to completion of the harness design. Thereafter, any changes made to the harness design necessitate similar changes to the testing apparatus, increasing the amount of work and cost incurred.

Accordingly, there is a need for a testing device that is both relatively compact and easy to store, and that allows for changes to be made to the wire harness without requiring complex changes to the testing apparatus.

### BRIEF SUMMARY

Some or all of the above-listed needs are met or exceeded by the present electrical continuity analyzer. In a first embodiment, a wireless electrical continuity analyzer of the present invention is used for testing the continuity of an electrical network having a plurality of testing points, each testing point including a plurality of pins. The analyzer includes a plurality of remote testers each having a wireless transceiver, a plurality of pin connectors, and a microcontroller. Each of the remote testers is connected to a power source, which can be a common power source or individual sources such as batteries. The pin connectors of each of the plurality of remote testers are configured for connection to pins of respective ones of the plurality of testing points. The continuity analyzer further includes a central computer system wirelessly connected to each of the plurality of remote testers. The central computer system sends a first wireless signal to a first of the remote testers activating at least one pin of the testing point associated with said first remote tester, and sends a second wireless message to all other remote testers to cause the other remote testers to sense voltages received at each pin.

Another embodiment of an electrical continuity analyzer is a non-transitory computer-readable recording medium storing an electrical continuity analyzer program. The program, when executed, operates a central computer in wireless communication with a plurality of remote testers. Each remote tester is connected to one of a plurality of testing points of an electrical network such as a wire harness, and each testing point includes a plurality of pins. The program, when executed by the central computer, causes the computer to perform steps including receiving configuration information specifying at least information identifying the testing points of the network to be analyzed and the remote tester associated with each testing point. The computer further transmits a first wireless message to a first of the plurality of remote testers. The first wireless message causes the first of the remote testers to activate at least one pin of the testing point associated with the tester. A second wireless message is transmitted to all others of the plurality of remote testers, causing the remote testers to sense voltages received at each pin of the associated testing point. The computer further waits to receive a response message from one or more of the other remote testing units, indicating at least at which pin a voltage was sensed and information indicating the voltage level sensed at the pin.

### BRIEF DESCRIPTION OF THE DRAWINGS

FIG. 1 is a schematic diagram of a wireless continuity analyzer of the present invention.

FIG. 2 is a schematic diagram of the central computer of the analyzer of FIG. 1;

FIG. 3 is a schematic diagram of one of the remoter testers of the analyzer of FIG. 1; and

FIG. 4 is a flow chart showing the operation of the continuity analyzer of FIG. 1.

### DETAILED DESCRIPTION

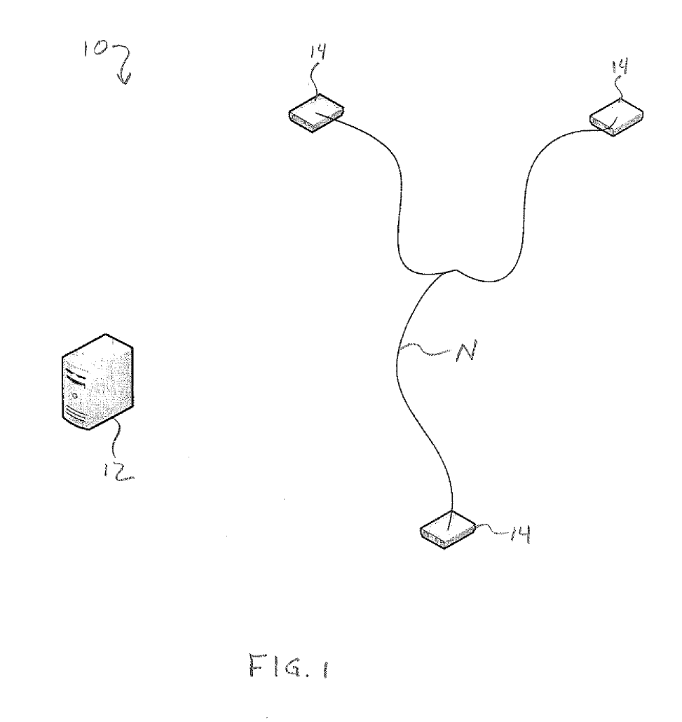

Referring now to FIGS. 1-3, an embodiment of a wireless electrical continuity analyzer is generally designated 10. The analyzer includes a central computer 12, and a plurality of remote testers 14 connected to an electrical network N, such as a wire harness.

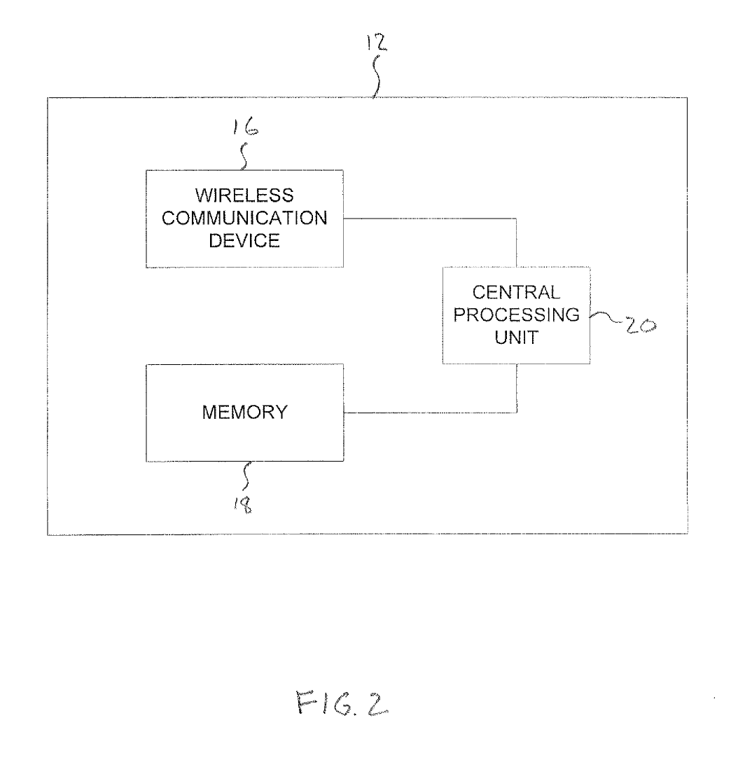

As shown in FIG. 2, the central computer 12 includes a wireless communication device 16 for wirelessly communicating with the plurality of remote testers 14. The wireless communication device 16 preferably uses a low-rate wireless personal area network as defined by the Institute of Electrical and Electronics Engineers (IEEE) 802.15, such as the ZIGBEE protocol. Other wireless personal area network protocols, such as BLUETOOTH or wireless USB, or wireless internet protocols as defined by IEEE 802.11 may also be used without departing from the scope of the present application. Additionally, a memory 18, which is preferably one or more non-transitory computer-readable media such as random access memory (RAM), read only memory (ROM), flash memory, a hard drive, a magnetic disk, and optical disk, a magneto-optical disk, or the like, stores a testing program for testing the continuity of the electrical network executed by a central processing unit 20 of the central computer 12.

Additionally, the central computer 12 stores information regarding the electrical network to be tested in memory 18. Preferably, the central computer 12 receives information such as a schematic diagram of the electrical network N, including how the network is wired and the location and number of pins at each testing point of the network. This allows the central computer 12 to form a virtual electrical network that corresponds to the actual electrical network N. Advantageously, this allows a user to easily and quickly update the virtual network if changes are made to the actual network N.

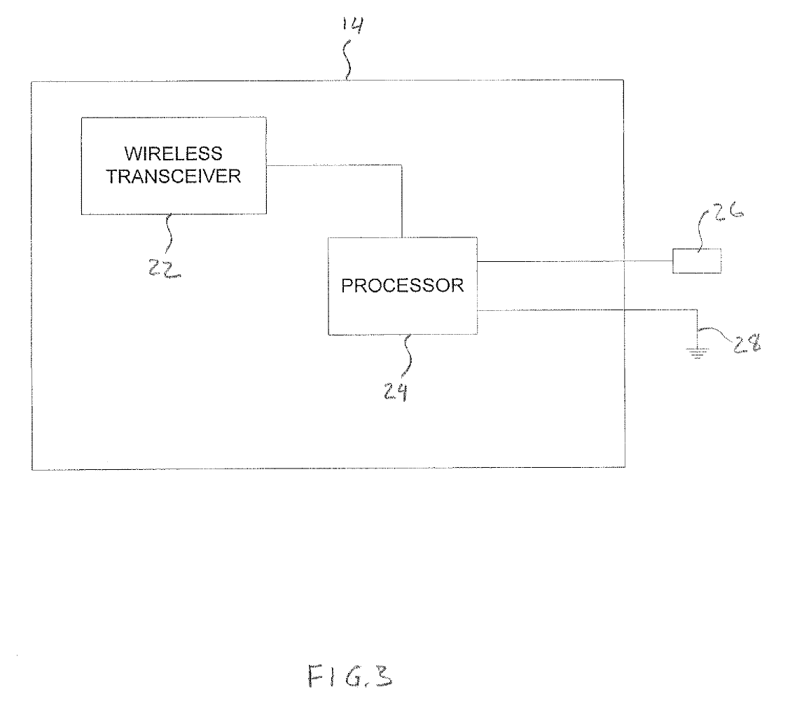

FIG. 3 shows a remote tester 14 that includes a wireless transceiver 22, a processor 24, and one or more cavities or pin connectors 26 for connecting to pins of the electrical network N. Each of the testers 14 is powered by conventional means, such as through mains power, battery power, etc. The testers 14 may be powered individually, or may share a single power source, Additionally, each of the remote testers 14 has a common ground connection 28 electrically connecting the remote tester to a common ground, such as by attaching each of the sensors to a common metallic chassis, wired ground net, ground strip, or the like. The common ground connection 28 helps to enable uniform voltage measurements across the plurality of remote testers 14.

The wireless transceiver 22 of each remote tester 14 uses the same protocol selected for use by the wireless communication device of the central computer 12. As such, the central computer 12 is in wireless communication with each of the testers 14. Additionally, the wireless transceivers 22 provide unique addresses to each remote tester 14, allowing each of the testers to be uniquely identified for purposes of sending and receiving communications to and from the central computer 12.

The processor 24 of the remote tester 14 executes commands received by the wireless transceiver 22, and causes the wireless transceiver to respond to the received commands. Additionally, the processor 24 is configured to sense voltage at each of the cavities 26, and to apply a voltage at each of the cavities.

The one or more cavities 26 of the remote tester 14 are configured to releasably retain pins disposed at testing points of the electrical network N, such that each cavity releasably retains a single pin in electrical communication with the cavity. Accordingly, while the remote tester 14 shown in FIG. 3 includes one cavity 26, the number of cavities on each remote tester is determined by the number of pins at the testing point with which the remote tester is associated.

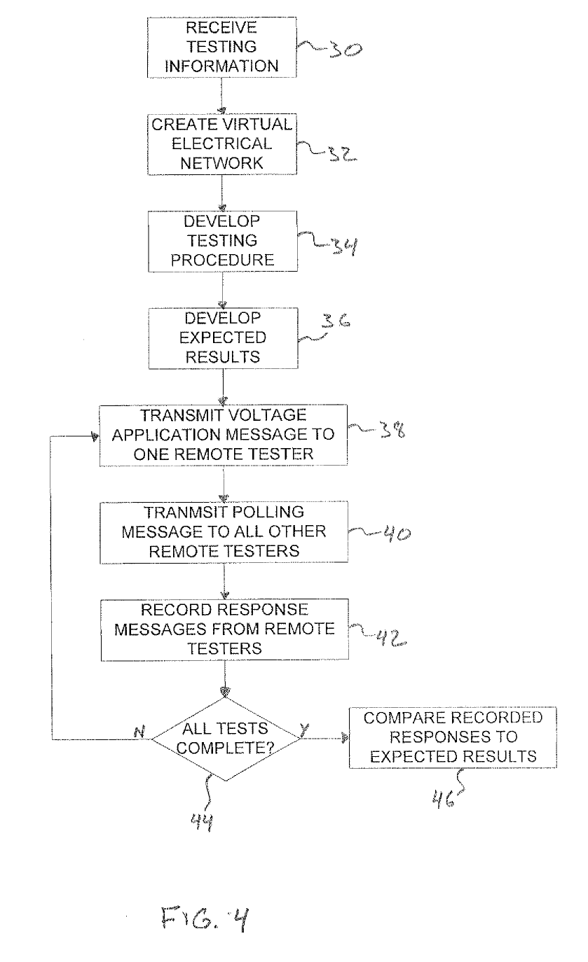

FIG. 4 is a flow chart showing the electrical network testing process performed by the analyzer 10. Initially, the central computer 12 receives testing information at least identifying each of the testing points of the electrical network N to be analyzed and which one of the remote testers 14 is associated with each of the testing points at a step 30. This allows the central computer 12 to assemble a virtualized electrical network at step 32.

A series of tests is then developed at step 34 to check the continuity and correct construction of the network. The tests may be developed automatically using the electrical network testing program of the central computer 12, developed manually by a user and input into the computer, or developed using some combination of automatic and manually-developed tests. The computer 12 then prepares a series of expected results for the developed tests on the basis of the virtualized electrical network at step 36.

Thereafter, the central computer 12 executes the developed tests by transmitting a series of instructions from the wireless communication device to one or more of the remote testers. As an example test, the central computer 12 first transmits a command to a single remote tester 14 to apply a voltage to one pin connected to the tester at step 38. The central computer 12 then transmits a command to each of the other remote testers 14 to place the remote tester into polling mode at step 40, polling received data at each of their associated pins, and waits to receive response messages from the remote testers.

In polling mode, the processor 24 of each remote tester 14 repeatedly senses the voltage applied to each pin at each of the cavities 26 with reference to the common ground 28. When the processor 24 detects a change in voltage at one or more pins of the electrical network, the processor causes the tester 14 to transmit a response message to the central computer 12 indicating at least at which cavity 26 the voltage was sensed, and the voltage level sensed at that cavity.

The central computer 12 then receives and records the response messages from the one or more remote testers 14 at step 42. Then at step 44, the central compute 12 determines whether all tests of the electrical network have been completed. If not all of the tests have been completed, the process returns to step 38.

Once all tests are completed (YES at step 44), the central computer 12 compares the recorded messages to the expected results of the test based on the virtualized network at step 46. In this way, the central computer 12 determines whether the electrical network N connected to the remote testers 14 meets the specifications of the virtual electrical network.

Additionally, it is contemplated that the remote testers 14 send an acknowledgement message to the central computer upon receipt of a command message. In this way, it is possible for the central computer 12 to determine whether a lack of response messages is due to a faulty electrical network N or an error in transmitting an instruction to a remote tester 14.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

1. A wireless electrical continuity analyzer for testing the continuity of an electrical network having a plurality of testing points, each testing point including a plurality of pins, the analyzer comprising:
a plurality of remote testers each including a wireless transceiver, a plurality of pin connectors, and a microcontroller, said pin connectors of each of said plurality of remote testers being configured for connection to pins of respective ones of the plurality of testing points;
at least one power source connected to each of said remote testers; and
a central computer system wirelessly connected to each of said plurality of remote testers, the central computer system sending a first wireless message to a first of said plurality of remote testers activating at least one pin of the testing point associated with said first remote tester, the central computer further sending a second wireless message to all others of said plurality of remote testers causing said other remote testers to sense voltages received at each pin.

2. The wireless electrical continuity analyzer of claim 1, wherein said central computer system is configured to store testing information specifying a configuration of the electrical network, identifying the testing points of the network to be analyzed, and associating one of said plurality of remote testers with each of the testing points.

3. The wireless electrical continuity analyzer of claim 2, wherein said central computer develops a series of tests to be performed on the electrical network and corresponding expected results based on said testing information.

4. The wireless electrical continuity analyzer of claim 3, wherein said others of said plurality of remote testers transmit response messages to said central computer in response to said second wireless message.

5. The wireless electrical continuity analyzer of claim 4, wherein said central computer compares said response messages to said expected results.

6. The wireless electrical continuity analyzer of claim 1, wherein each of said plurality of remote testers is connected to a common ground.

7. A non-transitory computer-readable recording medium storing an electrical continuity analyzer program for operating a central computer in wireless communication with a plurality of remote testers, each remote tester connected to one of a plurality of testing points of an electrical network, each testing point including a plurality of pins, the program, when executed by the central computer, causing the computer to perform steps comprising:
receiving testing information specifying a configuration of the electrical network, identifying the testing points of the network to be analyzed, and associating one of the plurality of remote testers with each of the testing points;
transmitting a first wireless message to a first of the plurality of remote testers, said first wireless message causing the first of the remote testers to activate at least one pin of the testing point associated with the tester;
transmitting a second wireless message to all others of the plurality of remote testers, said second wireless message causing the remote testers to sense voltages received at each pin of the associated testing point; and
waiting to receive a response message from one or more of the other remote testing units, said response message indicating at least at which pin a voltage was sensed and information indicating the voltage level sensed at the pin.

8. The non-transitory computer-readable medium of claim 7, the electrical continuity analyzer program further causing the central computer to develop a series of tests to be performed on the electrical network based on said testing information.

9. The non-transitory computer-readable medium of claim 8, the electrical continuity analyzer program further causing the central computer to develop expected results for said series of tests.

10. The non-transitory computer-readable medium of claim 9, the electrical continuity analyzer program further causing the central computer to compare said expected results to said response messages.

11. A continuity analysis method for testing the continuity of an electrical network having a plurality of testing points, each testing point including a plurality of pins, using a central computer in wireless communication with a plurality of remote testers, each remote tester connected to one of the plurality of testing points of the electrical network, comprising:
receiving testing information specifying a configuration of the electrical network at the central computer, said testing information identifying the testing points of the network to be analyzed, and associating one of the plurality of remote testers with each of the testing points;
transmitting a first wireless message from the central computer to a first of the plurality of remote testers, said first wireless message causing the first of the remote testers to activate at least one pin of the testing point associated with the tester;
transmitting a second wireless message from the central computer to all others of the plurality of remote testers, said second wireless message causing the remote testers to sense voltages received at each pin of the associated testing point; and
receiving a response message from one or more of the other remote testing units, said response message indicating at least at which pin a voltage was sensed and information indicating the voltage level sensed at the pin.

12. The method of claim 11, further comprising developing a series of tests to be performed on the electrical network based on said testing information.

13. The method of claim 12, further comprising developing expected results for said series of tests.

14. The method of claim 13, further comprising comparing said expected results to said response messages.

15. The method of claim 11, wherein the others of the plurality of remote testers transmit an acknowledgement message to the central computer in response to receiving said second wireless message.
